(19) United States
(12) Patent Application Publication
(10) Pub. No.: US 2019/0019405 A1
(43) Pub. Date: Jan. 17, 2019

(54) SYSTEM AND METHOD FOR MEASURING TRAFFIC BASED ON USER TERMINAL

(71) Applicant: NHN Entertainment Corporation, Seongnam-si (KR)

(72) Inventor: Chuljae LIM, Seongnam-si (KR)

(21) Appl. No.: 16/037,616

(22) Filed: Jul. 17, 2018

(30) Foreign Application Priority Data
Jul. 17, 2017 (KR) 10-2017-0090240

(51) Int. Cl. G08G 1/01; H04W 4/02

(52) U.S. Cl. CPC G08G 1/0125; G08G 1/012; H04W 4/02

(57) ABSTRACT

A method for measuring traffic of a user terminal performed on a traffic measuring device, the method including: collecting identification information of the user terminal as signal information for at least one or more Access Points (APs) located in a vicinity of the user terminal is received; and analyzing traffic of the user terminal according to the identification information of the user terminal based on location information of the user terminal estimated by using the received signal information.

### CROSS REFERENCE TO RELATED APPLICATION

This application claims priority from and the benefit of Korean Patent Application No. 10-2017-0090240, filed on Jul. 17, 2017, which is hereby incorporated by reference for all purposes as if fully set forth herein.

### BACKGROUND

### Field

Exemplary embodiments/implementations of the invention relate generally to a technology for measuring traffic through a user terminal.

### Discussion Of The Background

Usage of vehicles have increased due to increased supply of cars and the established culture for enjoying outdoor activities or leisure activities. However , road conditions may not properly accommodate for the rapidly increasing traffic demands. Meanwhile, efforts are continuously made to resolve the problem; for example, a way of effectively managing existing roads, extending new roads, and the like are representative. Accordingly, accurately and stably collecting traffic information such as traffic, speed, types of vehicle, and the like in corresponding roads is becoming important.

As an example of collecting traffic information, conventional technologies may obtain traffic data such as traffic, speed, share, number plate image by scanning vehicles passing each of roads through a combination of sensors installed in each of roads at intervals and collect vehicle number plate data with a camera installed in a lane.

However, the conventional technologies for measuring traffic depend on people, so there may be problems that it is impossible to consistently collect data, and installation cost is high. Also, when vehicular accidents occur, separate measures are needed to protect sensors on performing road construction, and it is difficult to classify types of passing vehicles.

The above information disclosed in this Background section is only for understanding of the background of the inventive concepts, and, therefore, it may contain information that does not constitute prior art.

### SUMMARY

Devices and methods according to exemplary embodiments of the invention are capable of providing a method and a device for measuring traffic on which anonymity is guaranteed based on identification information of a user terminal.

Additional features of the inventive concepts will be set forth in the description which follows, and in part will be apparent from the description, or may be learned by practice of the inventive concepts.

According to one or more embodiments of the invention, a method for measuring traffic of a user terminal performed on a traffic measuring device, the method includes: collecting identification information of the user terminal as signal information for at least one or more Access Points (APs) located in a vicinity of the user terminal is received; and analyzing traffic of the user terminal according to the identification information of the user terminal based on location information of the user terminal estimated by using the received signal information.

The collecting of the identification information of the user terminal may include storing identification information of the user terminal for authentication of the user terminal and access cycle information of the at least one or more APs that the user terminal attempted to access, wherein the user terminal may be configured to periodically attempt to access the at least one or more APs located in the vicinity of the user terminal.

The collecting of the identification information of the user terminal may include collecting a media access control (MAC) address of the user terminal.

The measuring of the traffic of the user terminal may include estimating location information of the user terminal based on signal information of each user terminal measured from the at least one or more APs collecting the identification information of the user terminal.

The measuring of the traffic of the user terminal may include analyzing whether the user terminal is moving based on signal strength and connecting time information included in the signal information of the user terminal.

The measuring of the traffic of the user terminal may include obtaining a moving route of the user terminal based on the estimated location information of the user terminal and access cycle information of the at least one or more APs that the user terminal attempted access.

The measuring of the traffic of the user terminal may include determining whether the user terminal is located on a sidewalk or a road based on moving speed information of the user terminal determined by analyzing the obtained moving route of the user terminal.

The measuring of the traffic of the user terminal may include determining distribution of the user terminal by counting the number of user terminals accessing to each of the at least one or more APs.

According to one or more embodiments of the invention, a traffic measuring device includes: a collecting unit configured to collect identification information of a user terminal in response to receiving signal information for at least one or more Access Points (APs) located in a vicinity of the user terminal; and an analyzing unit configured to analyze traffic of the user terminal according to the identification information of the user terminal based on location information of the user terminal estimated by using the received signal information.

The collecting unit may be configured to store identification information of the user terminal for authentication of the user terminal and access cycle information of the at least one or more APs that the user terminal attempted to access, wherein the user terminal is configured to periodically attempt to access the at least one or more APs located in the vicinity of the user terminal.

The collecting unit may be configured to collect a media access control (MAC) address of the user terminal.

The analyzing unit may be configured to estimate location information of the user terminal based on signal information of each user terminal measured from the at least one or more APs collecting the identification information of the user terminal.

The analyzing unit may be configured to analyze whether the user terminal is moving based on signal strength and connecting time information included in the signal information of the user terminal.

The analyzing unit may be configured to obtain a moving route of the user terminal based on the estimated location information of the user terminal and access cycle information when access to the at least one or more APs is attempted from the user terminal.

The analyzing unit may be configured to determine whether the user terminal is located on a sidewalk or a road based on moving speed information of the user terminal determined by analyzing the obtained moving route of the user terminal.

The analyzing unit may be configured to determine distribution of the user terminal by counting the number of user terminals accessing to each of the at least one or more APs.

According to one or more embodiments of the invention, a method for measuring traffic of a user terminal performed on an Access Point (AP), the method includes: receiving signal information of a Wireless Fidelity (Wi-Fi) signal from the user terminal; storing identification information of the user terminal included in the signal information; estimating location information of the user terminal according to the identification information of the user terminal based on the signal information; transmitting the estimated location information of the user terminal to a traffic measuring device; and analyzing traffic of the user terminal according to the identification information of the user terminal based on the estimated location information of the user terminal on the traffic measuring device.

The estimating of the location information of the user terminal may include calculating location information of the user terminal by sharing the received signal information from the user terminal.

The storing of the identification information of the user terminal may include collecting a media access control (MAC) address of the user terminal.

The analyzing of the traffic of the user terminal may include analyzing at least one of a moving route, a moving speed, or whether the user terminal is moving or not of the user terminal on the traffic measuring device as the location information of the user terminal is estimated.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

These and/or other aspects, features, and advantages of the invention will become apparent and more readily appreciated from the following description of embodiments, taken in conjunction with the accompanying drawings of which:

FIG. 1 illustrates an example of network environment according to an exemplary embodiment;

FIG. 2 is a block diagram of an example of a processor of a traffic measuring device according to an exemplary embodiment;

FIG. 3 is a flow chart illustrating a method of measuring traffic performed by a traffic measuring device according to an exemplary embodiment;

FIG. 4 is a flow chart illustrating a method of estimating location information of a user terminal performed by a traffic measuring device according to an exemplary embodiment;

FIG. 5 conceptually illustrates an operation of a traffic measuring device according to an exemplary embodiment;

FIG. 6 conceptually illustrates a method of estimating a location of a user terminal based on signal information of an AP (Access Point) existing around the user terminal on a traffic measuring device according to an exemplary embodiment;

FIG. 7 illustrates an exemplary method of storing traffic of a user terminal analyzed by a traffic measuring device according to an exemplary embodiment; and

FIG. 8 illustrates an exemplary method of indicating a moving route of a user terminal analyzed by a traffic measuring device according to an exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, regions, and/or aspects, etc. (hereinafter individually or collectively referred to as “elements”), of the various embodiments may be otherwise combined, separated, interchanged, and/or rearranged without departing from the inventive concepts.

In the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element or layer, there are no intervening elements present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, some example embodiments will be described in detail with reference to the accompanying drawings.

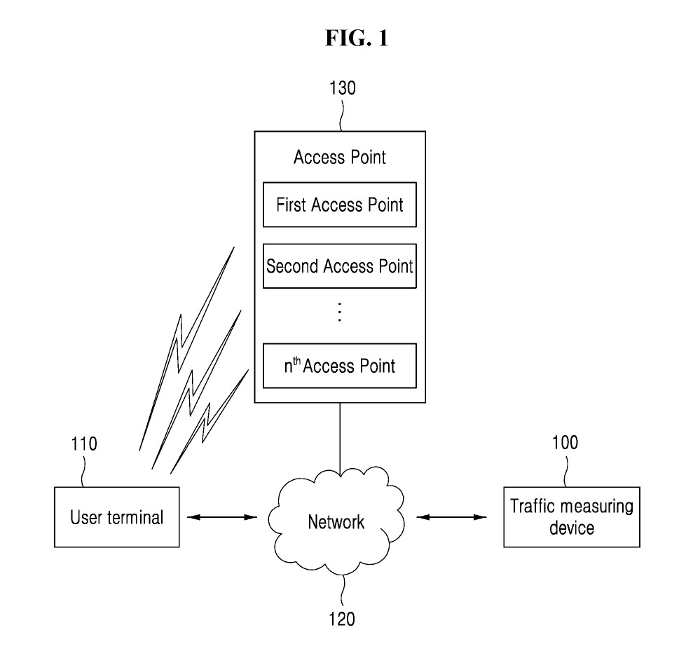

FIG. 1 illustrates an example of network environment according to an exemplary embodiment.

The network environment of FIG. 1 indicates an example including a user terminal 110, a traffic measuring device 100 (e.g., a server), and a network 120. Here, the user terminal 110 may be connected to an Access Point (AP).

The user terminal 110 may be a fixed terminal implemented by a computer or a portable terminal. As an example of the user terminal 110, there are a smart phone, a mobile phone, a navigation, a computer, a laptop, a digital broadcasting terminal, a Personal Digital Assistants (PDAs), a Portable Multimedia Player (PMP), a tablet personal computer (PC), and the like. For example, the user terminal 110 may communicate with other terminals and/or servers through the network 120 by using wireless or wired communication method.

The communication method is not limited and may include not only a communication method utilizing communication network (e.g. mobile communication network, the wired Internet, the wireless Internet, and broadcasting network) that the network 120 may include but also short-range wireless communication. For example, the network 120 may include any one or more network among networks of personal area network (PAN), local area network (LAN), campus area network (CAN), metropolitan area network (MAN), wide area network (WAN), broadband network (BBN), the Internet, and the like. Also, the network 120 may include any one or more among network topologies including bus network, star network, ring network, mesh network, star-bus network, tree or hierarchical network, and the like, but it may not be limited thereto.

The traffic measuring device 100 may be implemented with a computer device or a plurality of computer devices providing an instruction, a code, a file, content, a service, and the like by communicating through the user terminal 110 and the network 120. As an example, the traffic measuring device 100 may be a traffic measuring server providing a traffic measuring service to the user terminal 110 connected to the network 120 by using an AP 130.

The AP 130 may refer to a relay device helping wireless network access in order that the user terminal 110 connects to the network. For example, the AP 130 may be a Wireless-Fidelity (Wi-Fi) AP. When Wi-Fi is powered on at the user terminal 110, at least one or more AP 130 existing around or near by the user terminal 110 may be searched. Here, according to a distance between the user terminal 110 and the AP 130, the existing AP 130 may be differently searched.

The user terminal 110 may attempt to access to the Internet by receiving signal information of AP existing around the user terminal 110. Here, the AP 130 may share signal information received from the user terminal 110 with signal information of the user terminal 110 received from each of other APs existing around the AP 130.

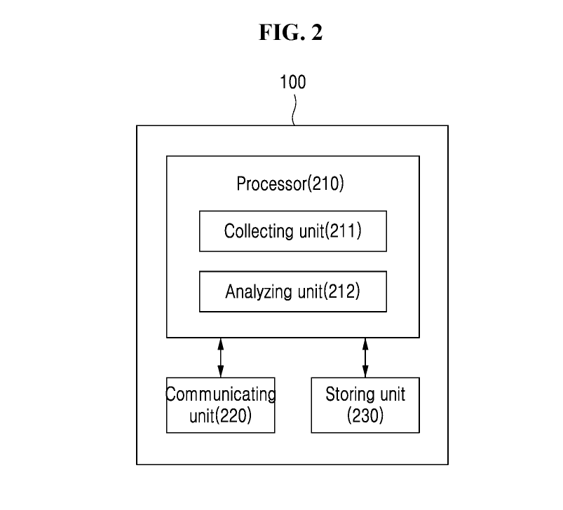

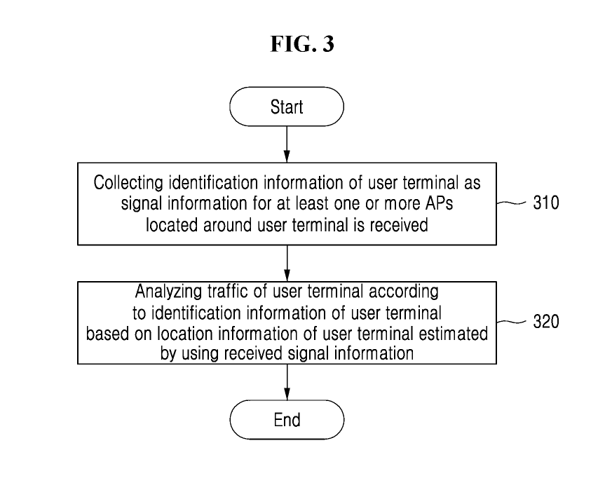

FIG. 2 is a block diagram of an example of a processor of a traffic measuring device according to an exemplary embodiment, and FIG. 3 is a flow chart illustrating a method of measuring traffic performed by a traffic measuring device according to an exemplary embodiment.

The traffic measuring device 100 may include a processor 210, a communication unit 220, and a storing unit 230 to provide a traffic measuring service. The processor 210 included in the traffic measuring device 100 may include a collecting unit 211 and an analyzing unit 212. Also, the communication unit 220 may transmit and receive data with a terminal and/or AP. The storing unit 230 may store and maintain analyzed information by estimating identification information (e.g., a MAC address) of a user terminal, signal information of the user terminal, location information of the user terminal, and location information of the user terminal.

The processor 210 and components of the processor 210 may control the traffic measuring device to perform operations 310 and 320 of a method of measuring traffic of FIG. 3. Here, the processor 210 and the components of the processor 210 may be implemented to execute instructions according to Operating System (OS) code and at least one program code that a memory includes. Here, the components of the processor 210 may be different functions performed by the processor 210 according to control instruction provided by the program code stored in the traffic measuring device 100.

The processor 210 may load the program code stored in a program file for the method of measuring traffic to a memory. For example, when executing the program on the traffic measuring device 100, the processor may control the traffic measuring device to load the program code to the memory from the program file according to OS control.

In operation 310, the collecting unit 211 may collect identification information of a user terminal as signal information for at least one or more APs located around the user terminal is received. The collecting unit 211 may collect identification information of the user terminal for authentication of the user terminal and access cycle information when access to APs is attempted from the user terminal as access to the APs existing around the user terminal is periodically attempted. Here, the collecting unit 211 may collect a MAC address as the identification information of the user terminal.

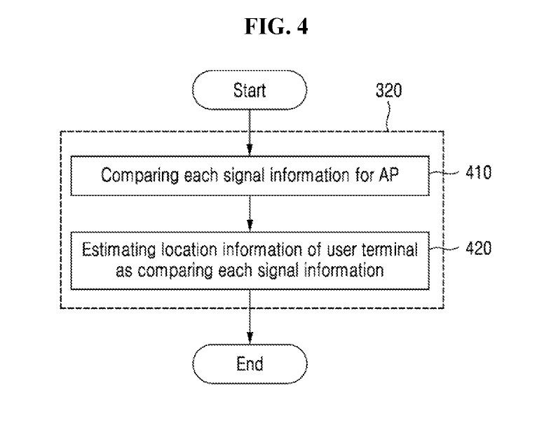

In operation 320, the analyzing unit 212 may analyze traffic of the user terminal according to identification information of the user terminal based on location information of the user terminal estimated by using the received signal information. Referring to FIG. 4, it is a flow chart for illustrating a method of estimating location information of a user terminal. In operation 410, the analyzing unit 212 may compare each signal information for AP received from the user terminal. The analyzing unit 212 may compare signal information through signal information of the user terminal received from each of APs collecting identification information of the user terminal, for example, signal strength, signal cycle information accessing to AP, and the like.

Location information of the user terminal may be estimated as each of the received signal information is compared in operation 420. Here, location information of the user terminal may be estimated by sharing signal information of the user terminal received from each of APs with APs. In other words, the analyzing unit 212 may more accurately estimate location information of the user terminal by comparing each of the received signal information based on location information of the user terminal estimated from each of APs.

For example, the analyzing unit 212 may analyze whether the user terminal moves or not based on signal strength and connecting time information included in the signal information of the user terminal. The analyzing unit 212 may also obtain a moving route of the user terminal based on access cycle information that access to the AP is attempted from the estimated location information of the user terminal and the user terminal. More particularly, the analyzing unit 212 may determine whether a location where the user terminal is located is sidewalk or road based on moving speed information of the user terminal determined by analyzing the obtained moving route of the user terminal.

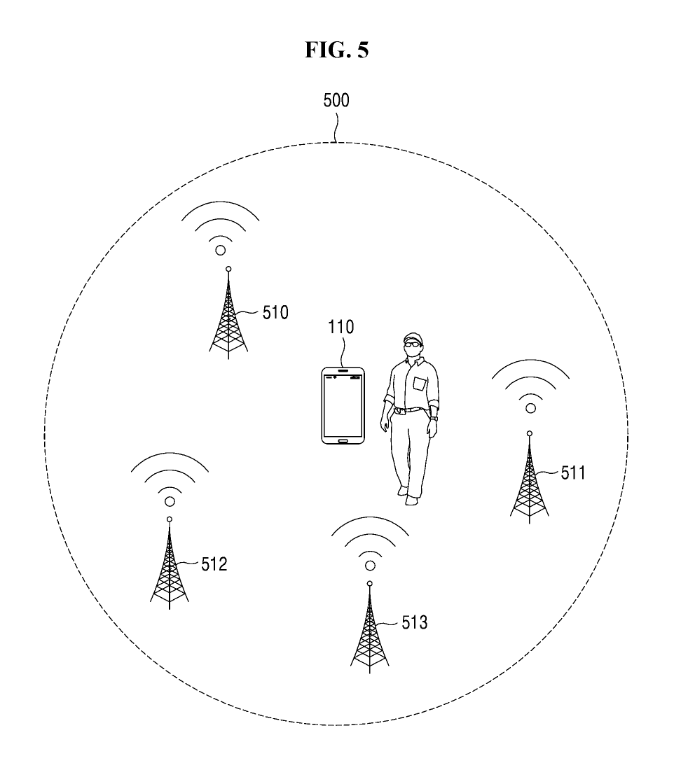

FIG. 5 conceptually illustrates an operation of a traffic measuring device according to an exemplary embodiment.

A traffic measuring device may collect identification information of the user terminal 110 as signal information for at least one or more APs 510, 511, 512, and 513 located around the user terminal 110. The user terminal 110 may periodically search the APs 510, 511, 512, and 513 located around the user terminal 110. Here, when the user terminal 110 and the APs 510, 511, 512, and 513 exist within a predetermined distance, the APs 510, 511, 512, and 513 may be searched in the user terminal 110. For example, when the user terminal 110 exists in an area 500 where signal transmitted from the APs 510, 511, 512, and 513 is searched, the APs 510, 511, 512, and 513 may be searched in the user terminal 110. When a distance between the user terminal 110 and AP is short, signal strength may have a great value, and when a distance between the user terminal 110 and AP is long, signal strength may have a small value. As the APs 510, 511, 512, and 513 existing around the user terminal 110 are searched, identification information (e.g., MAC address) of the user terminal may be transmitted to the APs 510, 511, 512, and 513. Here, although a MAC address may be changed by a user, the MAC address is generally not changed. Through this MAC address, it is possible to only confirm whether a unique user terminal exists or not, and it is not possible to determine detailed information relating to the user terminal.

The traffic measuring device may measure traffic on which anonymity is guaranteed through the MAC address of the user terminal 110. Accordingly, the traffic measuring device may measure traffic of the user terminal on which anonymity is guaranteed by receiving signal information of the user terminal on the traffic measuring device itself by having a function of AP, or may be configured in a form of measuring traffic by using separately signal information of the user terminal received from AP. Here, it is possible to receive signal information for AP of the user terminal at AP by installing or distributing modules, and operation for estimating location information of the user terminal may be performed according to signal information of the user terminal.

The traffic measuring device may more accurately determine location information of the user terminal by receiving identification information of the user terminal and location information of the user terminal received form AP. For example, each of at least one or more APs located around the user terminal may receive signal information of the user terminal. Here, the signal information received from each of APs may be different depending on a distance between the user terminal and the APs. Each of the at least one or more APs may store identification information of the user terminal as signal information of the user terminal is received. Here, it is possible to receive each other's MAC addresses as anonymous information before a Wi-Fi Hand Shake, and decibel information of the user terminal may be collected. Here, each of APs may compare signal information for the stored identification information of the user terminal. As the signal information of the user terminal is shared, each of APs may estimate location information of the user terminal based on the signal information compared from each of APs. In other words, the AP may determine whether the user terminal is located nearby. Accordingly, location information of the user terminal may be estimated, and the estimated location information of the user terminal may be transmitted to the traffic measuring device. The traffic measuring device may more accurately determine location information of the user terminal as the estimated location information of the user terminal is collected from AP. In other words, the traffic measuring device may determine location information of the user terminal based on each of signal information as signal information of the user terminal collected from each of APs is obtained. The traffic measuring device may analyze traffic of the user terminal on which anonymity is guaranteed based on location information estimated from each of APs.

According to the exemplary embodiments, the traffic measuring device may collect identification information of the user terminal as signal information for at least one or more APs located around the user terminal is received. Here, the traffic measuring device may collect identification information of the user terminal as signal information for AP is received from the user terminal. The traffic measuring device may estimate location information of the user terminal by using the received signal information. The traffic measuring device may analyze traffic of the user terminal according to identification information of the user terminal as location information of the user terminal is estimated.

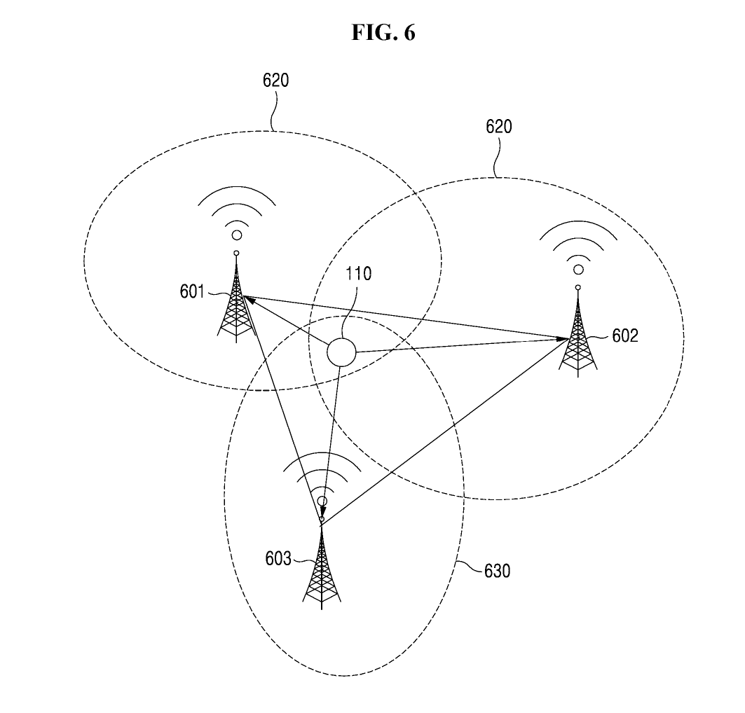

FIG. 6 conceptually illustrates a method of estimating a location of a user terminal based on signal information of AP (Access Point) existing around the user terminal on a traffic measuring device according to an exemplary embodiment.

The traffic measuring device may estimate location information of the user terminal as well as collect identification information of the user terminal based on signal information of AP existing around the user terminal. As illustrated on FIG. 6, Access Points, AP1 601, AP2 602, AP3 603 exist, and it is supposed that location coordinate of each of the APs is AP1 (x1, y1), AP2 (x2, y2), AP3 (x3, y3).

For example, the traffic measuring device may estimate location information of the user terminal based on trilateration. The trilateration is a principle of calculating a location of the user terminal 110 if locations of the three APs are known, and simultaneously distance from each of the APs is known.

For example, the traffic measuring device may estimate location information of the user terminal based on triangulation. The triangulation is a method of find coordinate and distance of a certain point by using property of triangle, and when there are a point and two reference points, it is a method of find coordinate and distance for the point by performing calculation by using sine rule after measuring each of angles formed with a base line and other two lines in a triangle formed by the point and the two reference points and the line.

According to the exemplary embodiments, the traffic measuring device may estimate location information of the user terminal based on signal strength included in signal information of the user terminal. As the signal strength of the user terminal is greater, it means that it is located close to AP. Therefore, location information of the user terminal may be estimated through signal strength of the user terminal measured at each of APs. Also, the traffic measuring device may estimate location information of the user terminal by combining the signal strength of the user terminal and the trilateration/the triangulation.

The traffic measuring device may more accurately determine location information of user terminal as the number of signal information of the user terminal received from each of the APs is more. Likewise, as location information of the user terminal is estimated, traffic of the user terminal according to the identification information of the user terminal may be analyzed.

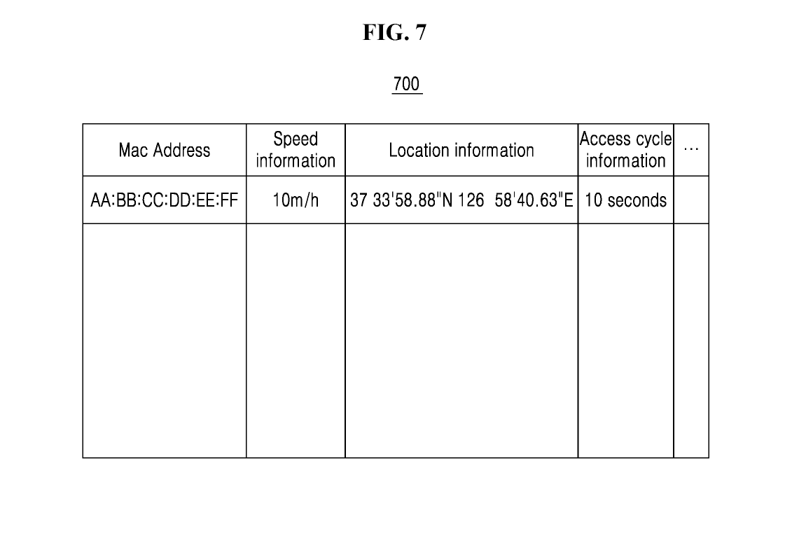

Referring to FIG. 7, illustrates an exemplary method of storing traffic of a user terminal analyzed by a traffic measuring device.

The traffic measuring device may store traffic information 700 according to identification information of the user terminal. The traffic measuring device may store traffic information 700 including the MAC address, speed information, location information, access cycle information, and the like of the user terminal in a database. The traffic measuring device may periodically update the traffic information 700 as location information of the user terminal is changed.

The traffic measuring device may estimate location information of the user terminal based on each of signal information of the user terminal measured from at least one or more APs collecting identification information of the user terminal. Here, the traffic measuring device may store measured coordinate information in the traffic information 700 as location information, and constantly accumulates the periodically measured coordinate information based on signal information of the user terminal. Accordingly, the traffic measuring device may obtain a moving route according to location information of the user terminal.

The traffic measuring device may store access cycle information that access to AP is attempted from the user terminal and information of AP that the user terminal is attempted to access. Also, the traffic measuring device may store moving speed information of the user terminal based on signal information received from the user terminal.

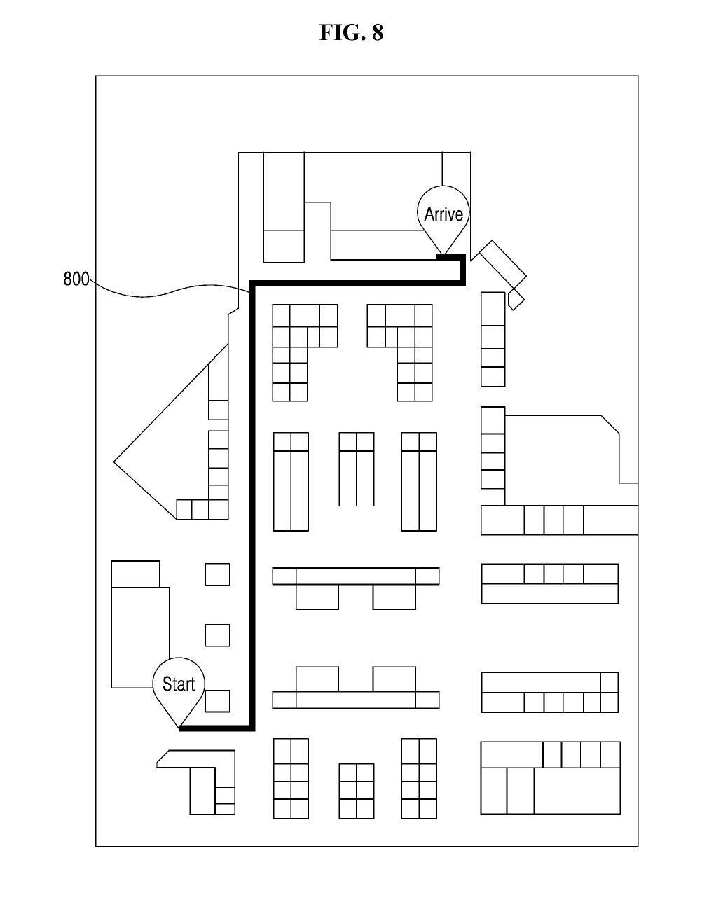

FIG. 8 illustrates an exemplary method of indicating a moving route of a user terminal analyzed by a traffic measuring device according to an exemplary embodiment.

The traffic measuring device may analyze traffic of the user terminal according to identification information of the user terminal. Here, the traffic of the user terminal may mean all information which may be analyzed from the user terminal. As an example, the traffic measuring device may determine traffic by determining the number of user terminals attempting to access to each of APs installed at a preset section. More particularly, the traffic measuring device may determine traffic passing the preset section according to information in which the number of the user terminals attempting to access to AP existing in the preset section changes after a preset time. Accordingly, the traffic measuring device may determine congested section in rush hour.

Also, the traffic measuring device may obtain a moving route 800 of the user terminal based on the estimated location information of the user terminal and the access cycle information that access to AP is attempted from the user terminal.

The traffic measuring device may measure traffic by counting the number of user terminals accessing to at least one or more APs. For example, according to signal information of the user terminal received from specific AP or/and the number of identification information of the user terminal, traffic of an area where the AP exists may be measured.

Also, the traffic measuring device may analyze even access information that the user terminal accessed to AP accesses. The traffic measuring device may analyze interest, tendency, and the like of the user terminal existing in an area where AP is installed. For example, the traffic measuring device may analyze a field of interest through information of sites searched by user terminals connected to AP. The traffic measuring device may analyze a field of interest of a user terminal by time and region with only identification information of the user terminal.

Also, the traffic measuring device may determine business value for a specific business based on traffic. For example, the traffic measuring device may determine that there is no business value for restaurant business in case of fast moving a specific area. The traffic measuring device may determine traffic in real-time, and make the traffic analyzed for determining business value to big data.

According to the exemplary embodiments, the traffic measuring device may analyze information of a user terminal while protecting personal information leakage because the traffic measuring device analyzes accessing information that the user terminal accesses through a MAC address of the user terminal.

According to the exemplary embodiments, the traffic measuring device may analyze whether the user terminal moves or not based on signal strength, connecting time information, and the like included in signal information of the user terminal. Also, the traffic measuring device may determine a location where the user terminal is located is a road or sidewalk based on the moving speed information of the user terminal determined by analyzing a moving route of the user terminal. For example, when a moving speed of the user terminal is 10 km/h, the traffic measuring device may determine that the user is moving on a sidewalk. Also, the traffic measuring device may estimate a bus by preregistering an AP which is installed in the bus in advance, and analyze traffic of the bus.

According to the exemplary embodiments, the traffic measuring device may display a moving route of the user terminal as a road on the user terminal as the traffic measuring device determines that the user terminal is moving on a road. For example, the traffic measuring device may provide a moving route of a vehicle on a navigation app operated on the user terminal.

Also, the traffic measuring device may predict traffic by combining specific information analyzed separately and traffic analyzed according to identification information of the user terminal when Wi-Fi is turned off on the user terminal.

According to the exemplary embodiments, a traffic measuring device may understand movement of a unique user terminal through identification information of the user terminal.

According to the exemplary embodiments, a traffic measuring device may detect advertising impact displayed on a unique user terminal through identification information of the user terminal.

According to an exemplary embodiment, a traffic measuring device may confirm a moving route of terminal collections of an area where a unique user terminal exists through identification information of the user terminal.

According to an exemplary embodiment, a traffic measuring device is possible to control traffic as well as to analyze traffic of a unique user terminal through identification information of the user terminal. For example, the traffic measuring device may control signal in order to disperse traffic in rush hour.

The units described herein may be implemented using hardware components, software components, and/or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

While certain example embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method for measuring traffic of a user terminal performed on a traffic measuring device, the method comprising:
collecting identification information of the user terminal as signal information for at least one or more Access Points (APs) located in a vicinity of the user terminal is received; and
analyzing traffic of the user terminal according to the identification information of the user terminal based on location information of the user terminal estimated by using the received signal information.

2. The method of claim 1, wherein the collecting of the identification information of the user terminal comprises storing identification information of the user terminal for authentication of the user terminal and access cycle information of the at least one or more APs that the user terminal attempted to access,
wherein the user terminal is configured to periodically attempt to access the at least one or more APs located in the vicinity of the user terminal.

3. The method of claim 1, wherein the collecting of the identification information of the user terminal comprises collecting a media access control (MAC) address of the user terminal.

4. The method of claim 1, wherein the measuring of the traffic of the user terminal comprises estimating location information of the user terminal based on signal information of each user terminal measured from the at least one or more APs collecting the identification information of the user terminal.

5. The method of claim 4, wherein the measuring of the traffic of the user terminal comprises analyzing whether the user terminal is moving based on signal strength and connecting time information included in the signal information of the user terminal.

6. The method of claim 4, wherein the measuring of the traffic of the user terminal comprises obtaining a moving route of the user terminal based on the estimated location information of the user terminal and access cycle information of the at least one or more APs that the user terminal attempted access.

7. The method of claim 6, wherein the measuring of the traffic of the user terminal comprises determining whether the user terminal is located on a sidewalk or a road based on moving speed information of the user terminal determined by analyzing the obtained moving route of the user terminal.

8. The method of claim 1, wherein the measuring of the traffic of the user terminal comprises determining distribution of the user terminal by counting the number of user terminals accessing to each of the at least one or more APs.

9. A traffic measuring device comprising:
a collecting unit configured to collect identification information of a user terminal in response to receiving signal information for at least one or more Access Points (APs) located in a vicinity of the user terminal; and
an analyzing unit configured to analyze traffic of the user terminal according to the identification information of the user terminal based on location information of the user terminal estimated by using the received signal information.

10. The device of claim 9, wherein the collecting unit is configured to store identification information of the user terminal for authentication of the user terminal and access cycle information of the at least one or more APs that the user terminal attempted to access,
wherein the user terminal is configured to periodically attempt to access the at least one or more APs located in the vicinity of the user terminal.

11. The device of claim 9, wherein the collecting unit is configured to collect a media access control (MAC) address of the user terminal.

12. The device of claim 9, wherein the analyzing unit is configured to estimate location information of the user terminal based on signal information of each user terminal measured from the at least one or more APs collecting the identification information of the user terminal.

13. The device of claim 12, wherein the analyzing unit is configured to analyze whether the user terminal is moving based on signal strength and connecting time information included in the signal information of the user terminal.

14. The device of claim 12, wherein the analyzing unit is configured to obtain a moving route of the user terminal based on the estimated location information of the user terminal and access cycle information when access to the at least one or more APs is attempted from the user terminal.

15. The device of claim 14, wherein the analyzing unit is configured to determine whether the user terminal is located on a sidewalk or a road based on moving speed information of the user terminal determined by analyzing the obtained moving route of the user terminal.

16. The device of claim 9, wherein the analyzing unit is configured to determine distribution of the user terminal by counting the number of user terminals accessing to each of the at least one or more APs.

17. A method for measuring traffic of a user terminal performed on an Access Point (AP), the method comprising:
receiving signal information of a Wireless Fidelity (Wi-Fi) signal from the user terminal;
storing identification information of the user terminal included in the signal information;
estimating location information of the user terminal according to the identification information of the user terminal based on the signal information;
transmitting the estimated location information of the user terminal to a traffic measuring device; and
analyzing traffic of the user terminal according to the identification information of the user terminal based on the estimated location information of the user terminal on the traffic measuring device.

18. The method of claim 17, wherein the estimating of the location information of the user terminal comprises calculating location information of the user terminal by sharing the received signal information from the user terminal.

19. The method of claim 17, wherein the storing of the identification information of the user terminal comprises collecting a media access control (MAC) address of the user terminal.

20. The method of claim 17, wherein the analyzing of the traffic of the user terminal comprises analyzing at least one of a moving route, a moving speed, or whether the user terminal is moving or not of the user terminal on the traffic measuring device as the location information of the user terminal is estimated.
